(19) United States
(12) Patent Application Publication
(10) Pub. No.: US 2011/0030366 A1
(43) Pub. Date: Feb. 10, 2011

(54) STIRLING ENGINE

(76) Inventor: Austin Liu, Richmond, CA (US)

Correspondence Address: DAVID A. GUERRA;INTERNATIONAL PATENT GROUP, LLC, Suite 700, 1816 Crowchild Trail N.W., CALGARY, AB, T2M 3Y7, CA

(21) Appl. No.: 12/988,676

(22) PCT Filed: Jun. 12, 2009
(86) PCT No.: PCT/US09/47188

§ 371 Date: Oct. 20, 2010

Related U.S. Application Data
(63) Continuation of application No. 61/060,870, filed on Jun. 12, 2008.

(51) Int. Cl. F02G 1/04

(52) U.S. Cl. 60/518

(57) ABSTRACT

A Stirling engine that implements a Stirling cycle is described. The Stirling engine may have a power piston and a main displacer coupled to a camshaft by means of a 90°-dwell positive return cam and yoke system. The Stirling engine achieves gaseous working fluid displacement using the main displacer and the co-displacer. The co-displacer alternately locks between the main displacer and the power piston, which enables the main displacer to displace a different volume of gaseous working fluid during a cooling phase of the Stirling cycle than during a heating phase of the Stirling cycle.

### RELATED APPLICATIONS

This application claims the benefit of and priority to U.S. provisional patent application No. 61/060,870 entitled “various designs and features including a Liu-Stirling engine and heat pump as well as a gradient maintaining counter flow heat exchanger”, filed Jun. 12, 2008. This application also is a continuation-in-part of and incorporates in U.S. provisional patent application No. 61/060,870 entitled “various designs and features including a Liu-Stirling engine and heat pump as well as a gradient maintaining counter flow heat exchanger” by reference.

### FIELD

An aspect of the invention is to create a more efficient Stirling engine.

### BACKGROUND

FIG. 1 illustrates a graph of some background but not necessarily prior art of an example gas working fluid distribution within a beta-configuration Stirling engine. The Graph represents two functions: the movement of the displacer of a beta-configuration Stirling engine pushing the working fluid between the heated and chilled chambers of the engine, and the movement of the piston, which controls the volume of the working fluid inside the engine. The vertical axis represents position, with the uppermost curve representing the volume of the Stirling engine as enforced by the piston's motion, and the curve underneath it representing the position of the displacer dividing the volume of the engine into one volume that is heated by the heat source and one that is chilled by the heat sink. The horizontal axis represents the position of rotation of the engine's drive shaft.

Observe that each phase involves mixed processes that are often self-antagonizing. This is largely due to the fact that beta-configuration Stirling engines are typically crank driven. These mixed-process phases of partial heating and partial cooling due to the sinusoidal motion of the piston and displacer are the reason why the typical beta-configuration Stirling engine's PV diagram follows the pseudo-Stirling cycle rather than more closely matching the Stirling cycle.

At point A, volume remains approximately steady (though not truly isochoric), displacer displaces working fluid through heat sink into the chilled chamber, but does so incompletely. Pressure drops due to temperature drop.

At point B, the displacer keeps most of the working fluid in the chilled chamber by not moving much, piston compresses low pressure working fluid. Heated portion of working fluid antagonizes this process.

At point C, volume remains approximately steady, displacer displaces working fluid through heat source into heated chamber. Pressure builds up dramatically due to greater proportion of displacement.

At point D, the displacer keeps most of the working fluid in the heated chamber, hot pressurized working fluid expands through heat sink to push against the piston. Expansion through heat sink antagonizes this process.

### SUMMARY OF INVENTION

A Stirling engine that implements a Stirling cycle is described. In an embodiment, the Stirling engine implements a Stirling cycle that is a closed cycle that continuously reuses its gaseous working fluid from cycle to cycle. The Stirling engine may have a power piston and a main displacer coupled to a camshaft that is a driveshaft for the engine by means of a 90°-dwell positive return cam and yoke system. The Stirling engine achieves gaseous working fluid displacement using the main displacer and the co-displacer. The co-displacer alternately locks between the main displacer and the power piston, which enables the main displacer to displace a different volume of gaseous working fluid during a cooling phase of the Stirling cycle than during a heating phase of the Stirling cycle.

### BRIEF DESCRIPTION OF THE DRAWINGS

The multiple drawings refer to the embodiments of the invention.

FIG. 1 illustrates a graph of some background but not necessarily prior art of an example gas working fluid distribution within a beta-configuration Stirling engine.

FIG. 2 illustrates a block diagram of a Stirling engine that has a power piston and a main displacer coupled to a camshaft that is a driveshaft for the engine by means of a 90°-dwell positive return cam and yoke system.

FIG. 3 illustrates a block diagram of the power piston, the main displacer and the co-displacer cooperating together to implement the (approximately) isothermal expansion phase starting from the hot compressed state of the Stirling cycle in order to increase efficiency and power density.

FIG. 4 illustrates a block diagram of the power piston, the main displacer and the co-displacer cooperating together to implement the isochoric (same volume) cooling phase starting from the hot expanded state of the Stirling cycle.

FIG. 5 illustrates a block diagram of the power piston, the main displacer and the co-displacer (4) cooperating together to implement the (approximately) isothermal compression phase starting from the cold expanded state of the Stirling cycle.

FIG. 6 illustrates a block diagram of an embodiment of the power piston, the main displacer and the co-displacer cooperating together to implement the isochoric heating phase starting from the cooled/chilled compressed state in the Stirling cycle.

FIG. 7 illustrates a block diagram of an embodiment of the co-displacer.

FIG. 8 illustrates a block diagram of an embodiment of the main displacer.

FIG. 9 illustrates a block diagram of an embodiment of the power piston.

FIG. 10 illustrates a graph of an embodiment of the gas working fluid distribution within the Stirling engine.

FIG. 11 illustrates a perspective diagram of an embodiment of the 90°-dwell positive return cam.

FIG. 12 illustrates a diagram of an embodiment of the 90°-dwell positive return cam illustrating the cam's profile with rounded corners while maintaining the same cam behavior.

FIG. 13 illustrates a sequential diagram of an embodiment of the 90°-dwell positive return cam.

FIG. 14 illustrates a cross-section of an embodiment of the power piston, the main displacer and the co-displacer cooperating together.

FIG. 15 illustrates a cross-section of an embodiment of the engine cylinder walls for the power piston, the main displacer and the co-displacer cooperating together.

FIG. 16 illustrates an example of a Stirling cycle pressure-volume phase and state diagram corresponding to FIGS. 3-6.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DISCUSSION

In the following description, numerous specific details are set forth, such as examples of specific pistons, named components, connections, types of practical applications using the design, etc., in order to provide a thorough understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Thus, the specific details set forth are merely exemplary. The specific details may be varied from and still be contemplated to be within the spirit and scope of the present invention. The term coupled means directly connected to or indirectly connected to via through another component.

An example process of and apparatus to provide Stirling engine, such as a Liu-Stirling engine are described.

The Stirling engine may have a power piston and a main displacer coupled to a camshaft that is a driveshaft for the engine by means of a 90°-dwell positive return cam and yoke system. The Stirling engine achieves gaseous working fluid displacement using the main displacer and the co-displacer. The co-displacer alternately locks between the main displacer and the power piston, which enables the main displacer to displace a different volume of gaseous working fluid during a cooling phase of the Stirling cycle than during a heating phase of the Stirling cycle.

The Stirling engine is designed to achieve a much higher power density and a significantly higher efficiency compared to prior forms of Stirling engines based on the classic configurations. This should permit this Stirling engine to successfully compete against internal combustion engines on account of the benefits of Stirling engines, namely high efficiency, clean emissions, silent operation, fuel flexibility, and simplicity. Historically, Stirling engines have had power densities too low to be used in most of the applications currently dominated by internal combustion engines.

Some specific advantages of this engine include the following:

1. The engine implements the processes that compose the Stirling cycle in discrete phases, resulting in a thermodynamic cycle that is much closer to the ideal cycle compared to the cycles of conventional Stirling engines.

2. This engine's configuration permits it to be designed with an arbitrarily high fixed compression ratio without the limitations that restrict conventional Stirling engines. High compression ratios are one of the factors that result in high power density; conventional Stirling engines are intrinsically limited to relatively low compression ratios.

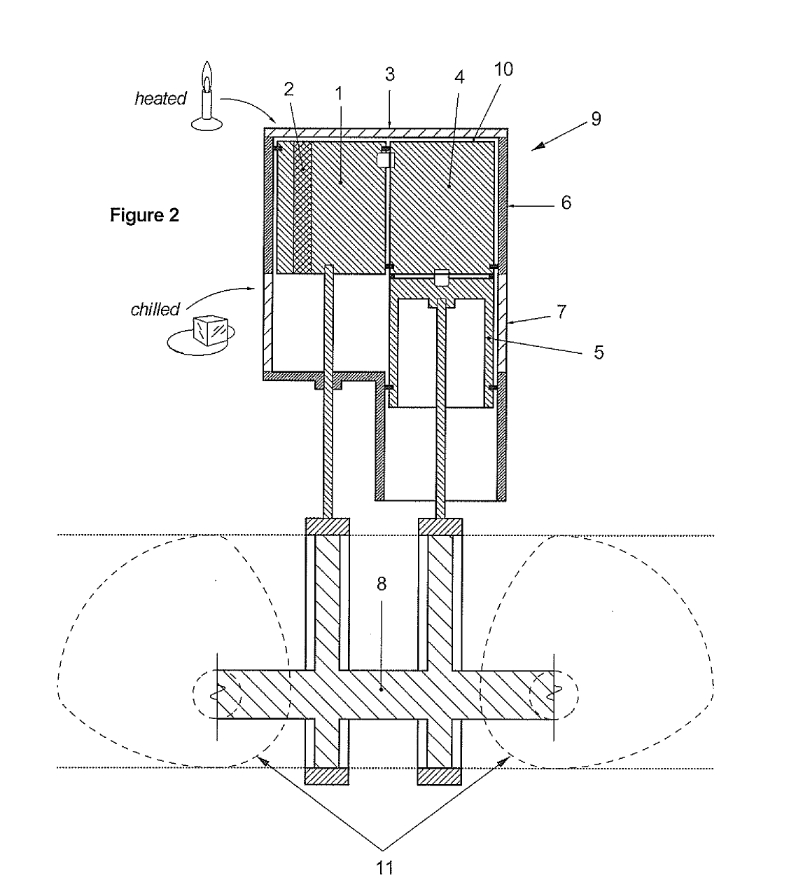

FIG. 2 illustrates a block diagram of a Stirling engine that has a power piston and a main displacer coupled to a camshaft that is a driveshaft for the engine by means of a 90°-dwell positive return cam and yoke system. The engine cylinder (9) has a main displacer (1) with a regenerator (2) of highly porous material to permit passage of gases without much resistance and is integrated into a portion of the displacer's body, a latch to mechanically lock with the co-displacer (4), a second latch plate for locking a motion of the co-displacer (4) with the power piston (5), and a narrow plenum (10) exist between the top of the body of the co-displacer (4) and the inside wall of the top of the engine cylinder wall where the heat source exchanger surface exists (3).

A pushrod couples to the body of the main displacer (1). A first yoke couples to the pushrod. A cam (11) and camshaft (8) are inside the yoke. Another pushrod couples to the body of the power piston (5). A second yoke couples to this pushrod. The power piston (5) and the main displacer (1) couple to the camshaft (8) by means of the 90°-dwell positive return cam and yoke system.

A heat source supplies heat to the top wall (3) of the engine cylinder where highly heat conductive material exists. The side engine cylinder walls (6) have relatively low heat conductivity material and possibly are insulated, if practical. A heat sink removes heat from the bottom side walls (7) of the engine cylinder where highly heat conductive material exists.

The Stirling engine implements a Stirling cycle that is a closed cycle engine that continuously reuses its gaseous working fluid from cycle to cycle. The co-displacer (4), in which the Stirling engine achieves gaseous working fluid displacement using the main displacer (1) and the co-displacer (4). The co-displacer (4) alternately locks between the main displacer (1) and the power piston (5), which enables the main displacer (1) to displace a different volume of gaseous working fluid during a cooling phase of the Stirling cycle than during a heating phase of the Stirling cycle.

The power piston (5) is aligned concentrically to the co-displacer (4) in the cylinder in which the power piston (5) moves, while the co-displacer (4) has two or more latches to including a first latch to the main displacer (1) and a second latch to the power piston (5) to separate the volume inside the shared engine cylinder (9) into two areas, one heated, and one chilled.

The Stirling cycle uses an external heat source, which could be anything from gasoline to solar energy to the heat produced by decaying plants. No combustion takes place inside the cylinders of the engine. The heat source is at a high temperature such as 800° K, 980° F., and the heat sink is at a low temperature such as below 200° F.

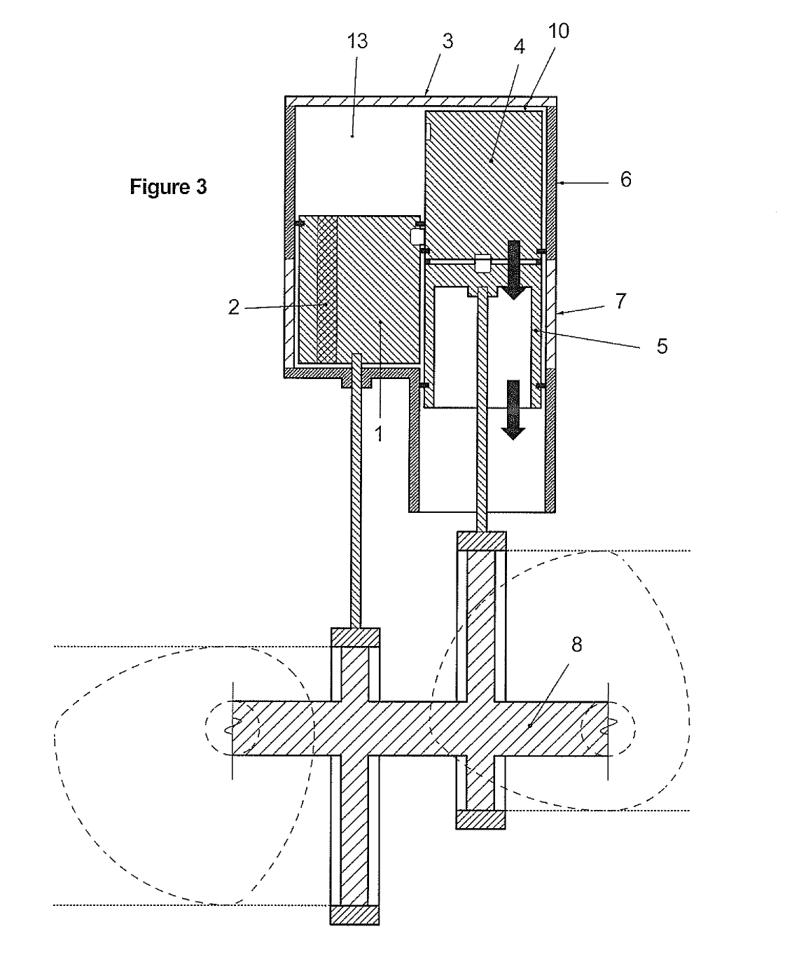

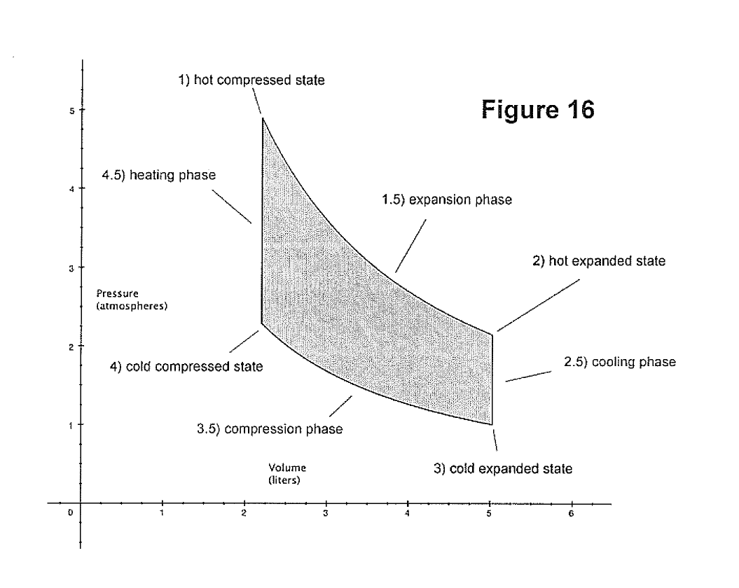

Next, the Stirling engine operation and the transitions between the states of the gaseous working fluid in the four distinct phases of the Stirling cycle are described. Each of the four phases of the Stirling cycle are supposed to support one ideal process per phase. These processes can be grouped into two types of operations: pure volume changes at a near constant temperature (isothermal expansion and compression) and pure temperature changes at a near constant volume (isochoric heating and cooling). Two moving parts internal to the Stirling engine govern these phases: the power piston (5) governs the volume inside the engine and the main displacer (1) pushes the working fluid between the heat source and heat sink to change its temperature. In FIGS. 3-6 of the Stirling Engine, each state of the engine transitions to the next state via the phase of the Stirling cycle described below. FIG. 16 illustrates an example phase and state diagram corresponding to FIGS. 3-6. The last state transitions back to the first state and repeats the process.

A key principle of a Stirling engine is that a fixed amount of a gas working fluid is sealed inside the engine. The Stirling cycle involves a series of events that change the pressure of the gas inside the engine, causing the engine to do work.

There are several properties of gases that are important to the operation of Stirling engines:
If you have a fixed amount of gas in a fixed volume of space and you raise the temperature of that gas by adding heat, the pressure will increase. When given an opportunity to change volume, the pressurized gas will expand until its pressure is at equilibrium with the pressure outside its container.
If you have a fixed amount of gas in a fixed volume of space and you lower the temperature of that gas by removing heat, the pressure will decrease. When given an opportunity to change volume, the depressurized gas will contract until its pressure is at equilibrium with the pressure outside its container.
If you have a fixed amount of gas in an insulated vessel and you compress the gas (decrease the volume of its space), the temperature of that gas will increase. When the same fixed amount of gas is compressed in a conductive vessel, the conductive vessel will conduct away heat, preventing the temperature of the gas from increasing.
If you have a fixed amount of gas in an insulated vessel and you decompress the gas (increase the volume of its space), the temperature of that gas will decrease. When the same fixed amount of gas is compressed in a conductive vessel, the conductive vessel will let the gas absorb heat from the vessel's surroundings, preventing the temperature of the gas from decreasing.

The gaseous working fluid (13) of the Stirling engine may be helium, hydrogen, potentially in combination with some volume of air.

FIG. 3 illustrates a block diagram of the power piston, the main displacer and the co-displacer cooperating together to implement the (approximately) isothermal expansion phase starting from the hot compressed state of the Stirling cycle in order to increase efficiency and power density. The arrows indicate that the phase (process, in this case, expansion) that transitions the working fluid to the next state.

The main displacer (1) serves to control when the gas chamber is heated and when it is cooled. In order to run, the engine requires a temperature difference between the top wall (3) and the bottom side walls (7) of the engine cylinder. The main displacer (1) moves up and down to control whether the gas working fluid (13) in the engine is being heated or cooled.

In this state, the gas working fluid (13) is hot because the displacer (1) is blocking/occluding the heat sink (7) from contact with the working fluid (13) while leaving the bulk of the working fluid (13) in contact with the heat source (3). The gas working fluid (13) is also compressed because the piston (5) is at its inmost position.

The co-displacer (4) unlatches from the displacer (1) and is latched to the piston (5) in this state, and remains latched throughout the expansion phase.

When the main displacer (1) is near the bottom of the engine cylinder, almost all of the gas inside the engine is heated by the heat source and the gas working fluid (13) will expand. Pressure builds inside the engine, forcing the power piston (5) down.

### Phase: Expansion

The pressure of the heated gas pushing against the piston and co-displacer performs work. Increasing the pressure during this part of the cycle will increase the power output of the engine. One way of increasing the pressure is by increasing the temperature of the gas.

The hot pressurized gas working fluid (13) expands by pushing the piston (5) and co-displacer (4) downwards. The co-displacer (4) couples to the power piston (5). The narrow plenum (10) exist between the top of the body of the co-displacer and the inside wall of the top of the engine cylinder wall so that the gas working fluid presses down on the power piston (5) via the coupled co-displacer (4) so that the gas working fluid (13) does not have to be exposed to the heat sink (7) in order to push down on the piston during the expansion phase.

Note, the displacer (1) does not move during this phase. Mechanically speaking this phase involves only a volume change. It is during expansion that heat enters the engine from the heat source (3) and the gas working fluid (13) in contact with the heat source (3) permits heat flowing in from the heat source (3) to counteract the temperature drop that naturally accompanies gas expansion. The engine tries to minimize the temperature drop to thereby minimize any pressure drop that accompanies expansion, and thus maximize the work output during this phase. The ideal cycle calls for isothermal expansion, but in operation if isothermal expansion is impossible, then the best that can be done is to minimize the temperature drop.

### Phase: Cooling

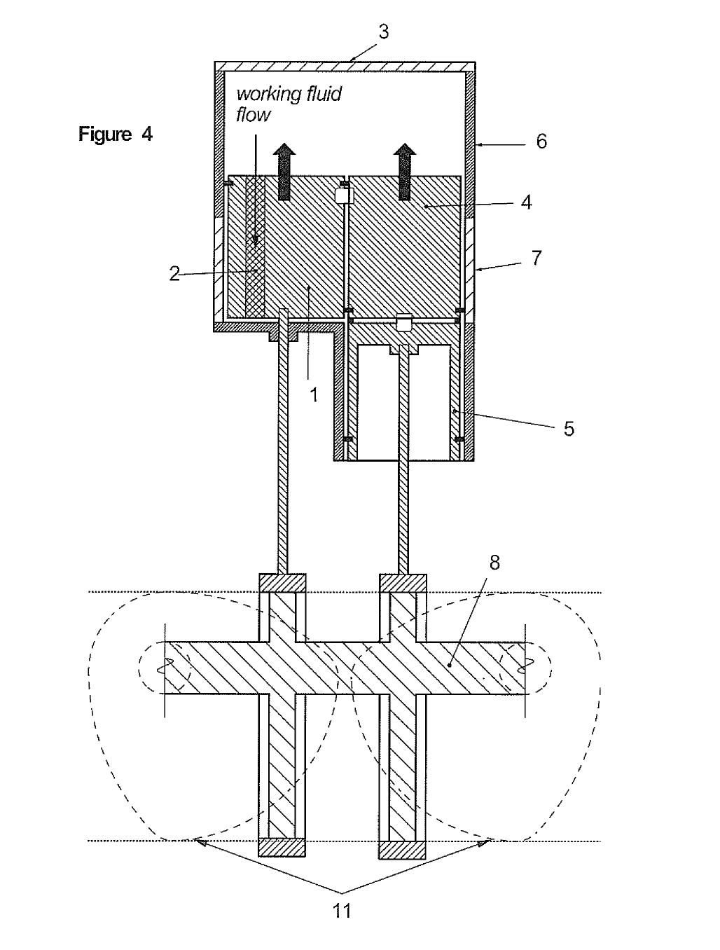

FIG. 4 illustrates a block diagram of the power piston, the main displacer and the co-displacer cooperating together to implement the isochoric (same volume) cooling phase starting from the hot expanded state of the Stirling cycle. The power piston (5), the main displacer (1) and the co-displacer (4) are in the position where the working fluid is hot and expanded.

In this state, the working fluid is hot because the heat sink (7) is still occluded, and the working fluid is still in contact with the heat source (3). The gas working fluid is expanded because the piston (5) is at its outermost position, having just gone through the expansion phase.

When both the displacer (1) and co-displacer (4) are forced near the bottom of the engine cylinder wall the gas working fluid is hot and fully expanded. The power piston (5) and yoke coupled to the co-displacer (4) have been forced down.

At this part of the cycle, the piston is already all the way out and has done all the work it can. The engine is about to cool the working fluid to lower its pressure so the gas working fluid can be easily compressed.

At this point, the co-displacer (4) unlatches from the piston and latches to the displacer (1), remaining latched throughout the following phase.

The regenerator conduit (2) is integrated into a body of the main displacer (1) and offers a passageway between a volume above the main displacer (1) and a volume below the main displacer (1). The regenerator (2) is made of a porous material with a high heat transfer/absorption capacity. The main displacer (1) pushes the gaseous working fluid from the heat source through the regenerator to the heat sink to change a temperature of the gaseous working fluid.

The gaseous working fluid distribution in the four distinct phases of the Stirling cycle is due to the geometry of the 90°-dwell positive return cams (11) that govern the movement of the main displacer (1) and the power piston (5). The movement of the power piston (5) and the main displacer (1) are mutually exclusive; when one moves, the other must remain still, and vice versa. The reciprocating movement of both the power piston (5) and the main displacer (1) is punctuated by pauses where each dwells at the end of its stroke as long as the other one is moving.

The positive return cams (11) pull on cam followers, where the positive return cams (11) sit inside yokes with parallel, flat bearing surfaces, and as the cams turn, they push on the bearing surfaces on one side of the yokes, then push on the bearing surfaces on the other side of the yokes upon the return stroke, while in contact with both bearing surfaces throughout the cycle, which then causes the return of the yoke by the cam's push on the return side's bearing surface.

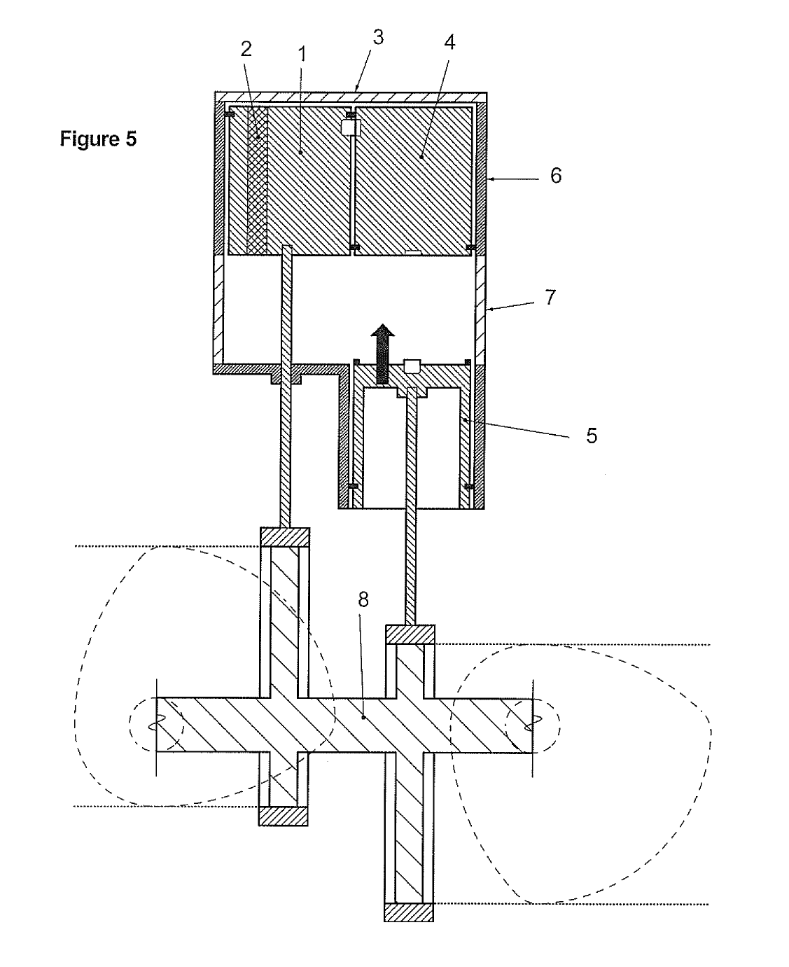

FIG. 5 illustrates a block diagram of the power piston, the main displacer and the co-displacer (4) cooperating together to implement the isothermal compression phase of the Stirling cycle starting from the cold expanded state.

The displacer (1), which is latched to the co-displacer (4), has moved towards the heat source surface (3), displacing all of the working fluid through the regenerator (2) towards the heat sink surface (7). The regenerator conduit (2) starts out cold, and absorbs heat from the working fluid passing through it, chilling the gas working fluid before letting the gas working fluid come in contact with the heat sink surface (7). The piston (5) does not move during this phase. The yoke coupled to the displacer (1) has been pulled up.

Note, other than minor changes in volume due to the displacer's pushrod entering the engine, this phase is essentially a temperature change.

The chilling effect during this phase is mainly due to the regenerator (2) absorbing heat out of the working fluid rather than the heat sink surface (7) chilling the working fluid. Ideally, the regenerator (2) chills the working fluid down to the temperature of the heat sink so that the heat sink does not have to chill the working fluid any further; any residual temperature difference between the working fluid and the heat sink surface (7) indicates inefficiency on the part of the regenerator (2).

Thus, most of the gas working fluid has moved from the heating area by the heat source heat exchanging surface (3) through the regenerator (2) and into the cooled area by the heat sink heat exchanging surface (7). The regenerator (2) is a device that can temporarily store heat and might consists of a mesh of wire that the heated gas working fluid passes through or a porous material that has a high heat absorption capacity. The large surface area of the wire mesh/porous material quickly absorbs most of the heat. This leaves less heat to be removed by the cooling fins/heat sink. In an embodiment, the engine's regenerator sits within a conduit. The conduit can be located either 1) within the main displacer (1) or 2) outside the cylinder and the conduit connecting the volume on a heat sink side of the displacer to the volume on a heat source side of the displacer, 3) or pass through any of the internal components of the engine.

At least a portion of the co-displacer (4) and the main displacer (1) and possibly a seal between the bodies of the co-displacer (4) and main displacer (1) abut to span across the width of the engine cylinder such that the gaseous working fluid cannot pass from a first area (3) in contact with a heat source to a second area (7) of the engine cylinder in connection with a heat sink without passing through the regenerator conduit (2).

In this state, the working fluid is cold because it is in contact with the heat sink (7) while the displacer (1) and co-displacer (4) occlude the heat source (3). The working fluid is also expanded because the piston (5) is at its outermost position. The co-displacer (4) and the displacer remain latched throughout this phase.

### Phase: Compression

The large arrow in FIG. 5 shows that the piston moves up to take the working fluid to the next state.

The piston (5) moves into the engine, compressing the cold working fluid. The power piston (5) governs the volume inside the Stirling engine. At the top of the stroke, the piston (5) latches to the co-displacer (4), which simultaneously unlatches from the displacer (1).

Note, because the displacer (1) does not move during this phase, this phase involves only volume change. It is during compression that heat is given off from the working fluid into the heat sink (7); gases naturally heat up when compressed, so the working fluid's contact with the heat sink surface (7) permits the heat sink to counteract any heating. Reduced compressive heating results in less work being done by the engine during the compression phase, which increases net work output. The heat sink chills the engine cylinder wall by a water jacket or cooling fins.

At the end of the piston stroke, the working fluid is still cold because the displacer's (1) current position leaves the gas working fluid in contact with the heat sink (7), and compressed because the piston (5) is in its deepest position into the engine. The co-displacer (4) and the piston latch and then remain latched together during the following phase.

### Phase: Heating

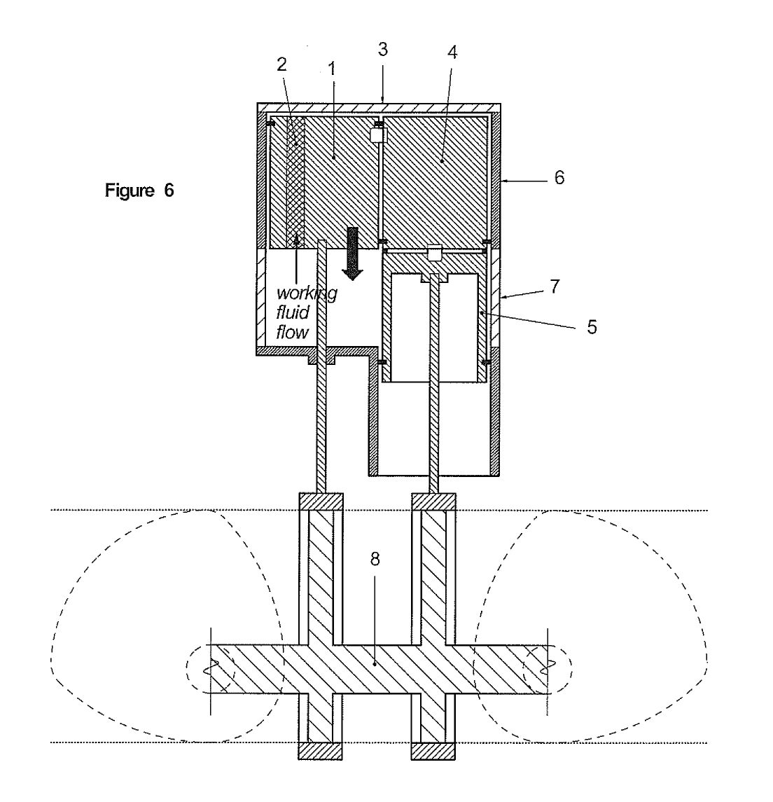

FIG. 6 illustrates a block diagram of an embodiment of the power piston, the main displacer and the co-displacer cooperating together to implement the isochoric heating phase starting from the cooled/chilled compressed state in the Stirling cycle.

The displacer (1) moves towards the heat sink (7), displacing the working fluid through the regenerator (2) towards the heat source (3) as shown in FIG. 3. The regenerator (2), still full of heat absorbed during the chilling phase, warms up the working fluid as shown here in FIG. 6.

Note, the piston (5) does not move during this heating phase. Other than minor changes in volume due to the displacer's pushrod entering the engine, this heating phase is essentially a temperature change. It is important to note that the heating effect during this phase is mainly due to the regenerator (2) rather than the heat source. Ideally, the regenerator (2) heats the working fluid up to the temperature of the heat source so that the heat source does not have to heat the working fluid any further; any residual temperature difference between the working fluid and the heat source indicates inefficiency on the part of the regenerator (2).

Overall, during these four phases, the engine repeatedly heats and cools the gas, extracting energy from the gas's expansion and contraction. The co-displacer (4) also enables the power piston (5) and the main displacer (1) to operate in the same volume while exerting influence on the entire volume of gaseous working fluid.

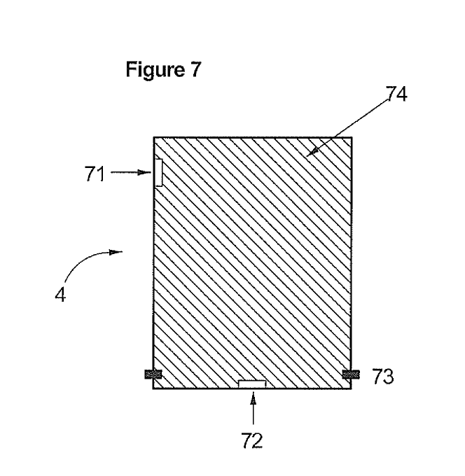

FIG. 7 illustrates a block diagram of an embodiment of the co-displacer.

The co-displacer (4) has a first latch plate (71) for locking a motion of the co-displacer (4) with the displacer, a second latch plate (72) for locking a motion of the co-displacer (4) with the power piston (5), a body (74) connected to the first latch plate (71) and the second latch plate (72), and a seal (73).

Note, a motion of the co-displacer (4) may be mechanically locked with the main displacer and power piston or configured to merely track and mimic and reinforce the motion of those two components during the specific phases of the Stirling cycle. The latches (71, 72) may also create a magnetic lock.

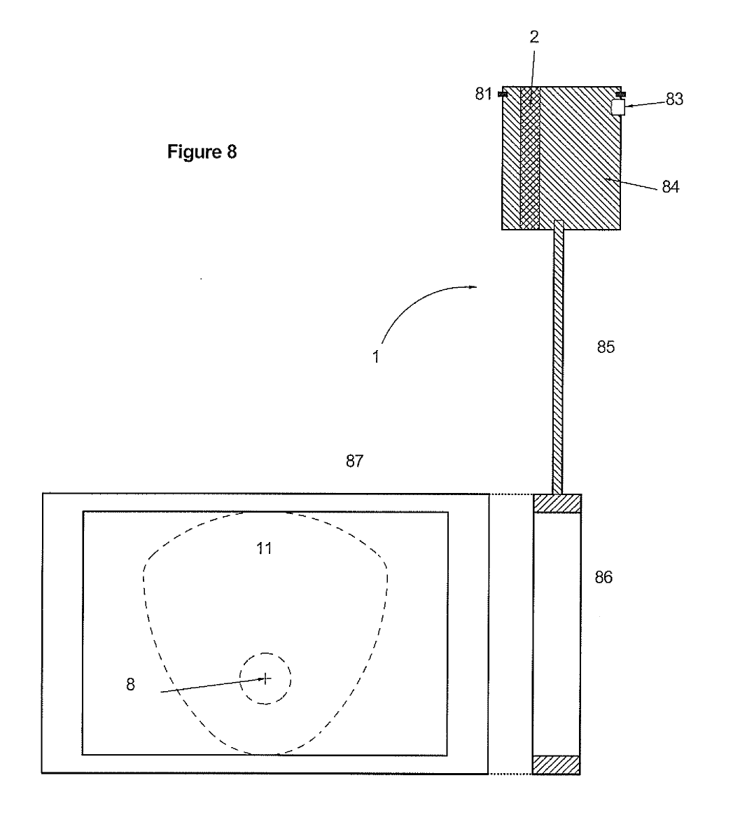

FIG. 8 illustrates a block diagram of an embodiment of the main displacer.

The main displacer (1) has a regenerator (2) of highly porous material to permits passage of gases without much resistance integrated into a portion of the displacer's body (84), a latch (83) to mechanically lock with the co-displacer, a pushrod (85) coupled to the body (84) of the displacer, a yoke (86) coupled to the pushrod (85), and a seal (81).

FIG. 8 also shows a side view of yoke (86) with a dashed outline showing where the 90°-dwell positive return cam (11) and camshaft (8) would fit inside the yoke (86).

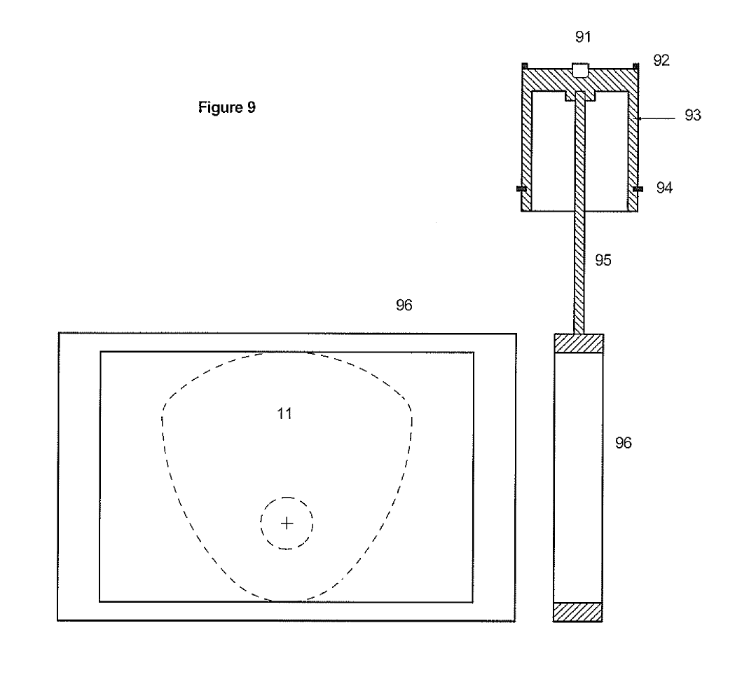

FIG. 9 illustrates a block diagram of an embodiment of the power piston. The piston (5) may have a latch (may be mechanical or magnetic) (91), a bumper (92) to cushion contact between the power piston (5) and the co-displacer, a piston body (93), a seal (94), a pushrod (95), and a yoke (96).

FIG. 9 also shows a side view of yoke (96) with a dashed outline showing where the 90°-dwell positive return cam (11) and camshaft would fit inside the yoke (96).

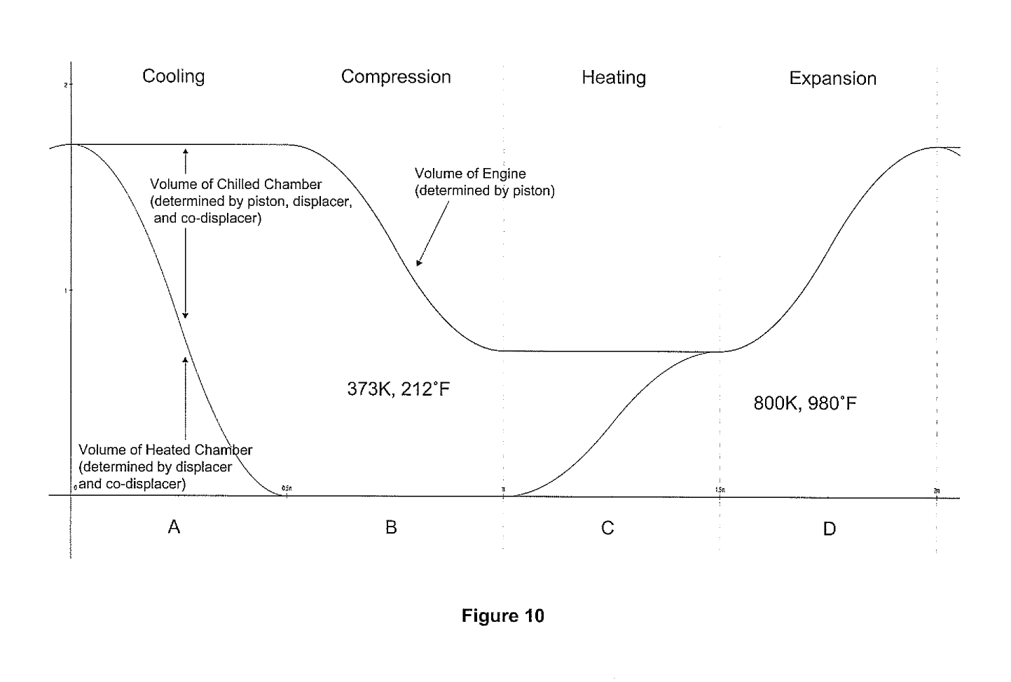

FIG. 10 illustrates a graph of an embodiment of the gas working fluid distribution within the Stirling engine implementing the four discrete phases of the Stirling cycle. The vertical axis represents position, with the uppermost curve representing the volume of the Stirling engine as enforced by the piston's motion, and the curve underneath it representing the position of the displacer dividing the volume of the engine into one volume that is heated by the heat source and one that is chilled by the heat sink. The horizontal axis represents the position of rotation of the engine's drive shaft. As discussed, the piston, and displacer/co-displacer influence the engine's work cycle. The graph represents two functions: 1) the movement of the displacer and co-displacer pushing the working fluid between the heated and chilled chambers of the engine, and 2) the movement of the piston, which controls the volume of the working fluid inside the engine. The volume of the regenerator has been omitted for clarity; it is small compared to the over-all volume of the engine and remains constant.

The Stirling cycle consists of two isothermal volume changes where heat is transferred through the heat source and heat sink, and two isochoric (constant volume) temperature changes where the regenerator is responsible for heating and cooling the working fluid.

At point A, volume remains constant for true isochoric cooling. The displacer and co-displacer almost completely displace the working fluid into the chilled chamber. The temperature drop results in a pressure drop unmitigated by premature compression.

At point B, the piston compresses the chilled, low pressure working fluid, without the antagonizing effect of a significant portion of the working fluid exposed to the heat source. Compression is much more nearly isothermal due to complete and sustained displacement; true isothermal conditions may be impossible to achieve.

At point C, volume remains constant for nearly true isochoric heating. The displacer almost completely displaces the working fluid into the heated chamber. The temperature increase results in a sharp increase in pressure unmitigated by pre-mature expansion.

At point D, the hot pressurized working fluid expands against the piston without expanding through the heat sink. Because there is no antagonizing portion of the working fluid being chilled, the pressure remains higher throughout expansion. Expansion is very nearly isothermal with sustained and complete displacement.

Positive return cams perfectly implement this switch between stroking and dwelling, even affording smooth transitions between the phases. Throughout each phase, the slope of one function is zero while the other is non-zero. Notice that in the middle of each of the four phases A-D, there is a range where there is maximum change in one function coinciding with no change in the other. The displacement functions result on the PV diagram of the Stirling engine in a much more complete extraction of available energy in the form of work performed on the camshaft/driveshaft.

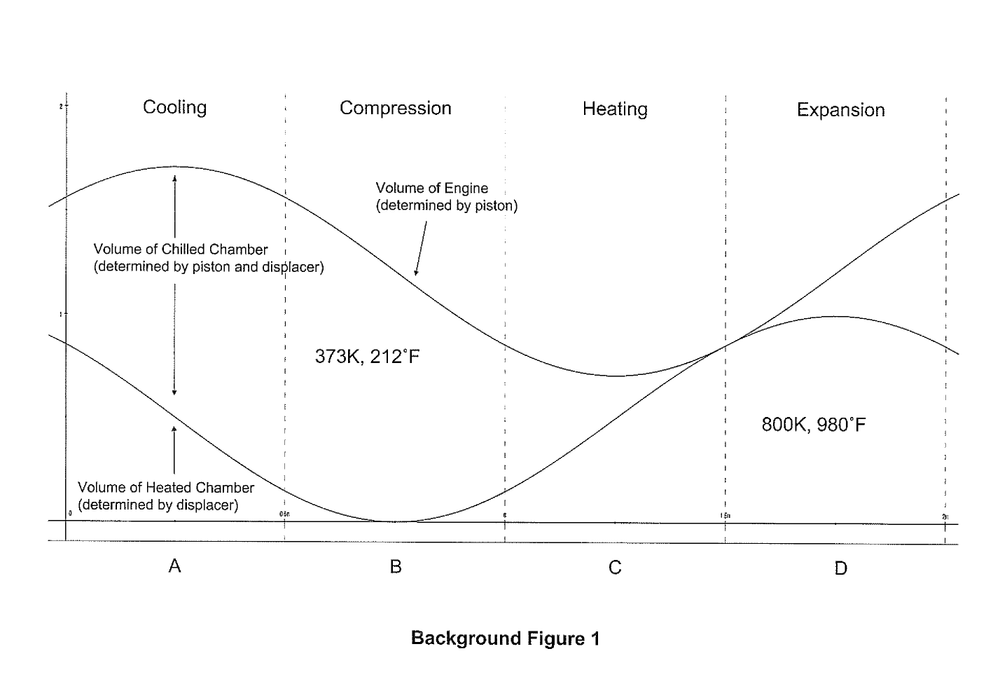

Comparing FIG. 10 with the motion of cranks shown in FIG. 1; the graph shows that the four phases of the Stirling cycle are very poorly approximated in FIG. 1. The cranks in the example beta Stirling engine merely manage to match ideal conditions in the middle of each phase. Everywhere else, sinusoidal action deviates significantly from the ideal.

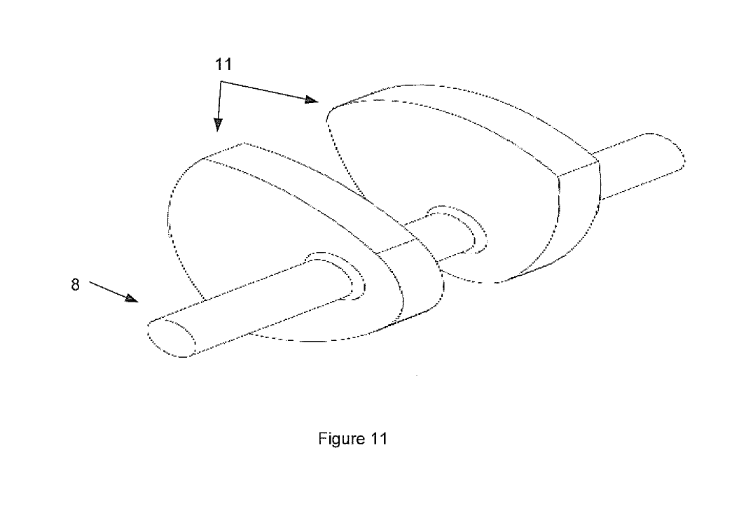

FIG. 11 illustrates a perspective diagram of an embodiment of the 90°-dwell positive return cam. The positive return cams (11) that govern the engine's action are phase-shifted by 90°. Given clockwise rotation, the cam in front governs the piston, and the cam behind it governs the main displacer. Throughout the shaft's rotation, one cam's dwell period corresponds to the other's stroking period. The positive return cams (11) have a phase difference between them of exactly 90°, which sets the dwell period of one cam to the stroke periods of the other throughout the entire rotation of the drive shaft.

The positive return cams (11) and cam shaft (8) assembly rotates clockwise. The cam that governs the displacer is 90° ahead of the cam that governs the piston because in the Stirling engine the displacer's motion necessarily precedes the piston's. The piston's motion following the completion of the pressure change then either extracts work from the hot, pressurized gas via expansion, or compresses the chilled, low-pressure gas to prepare for the next cycle.

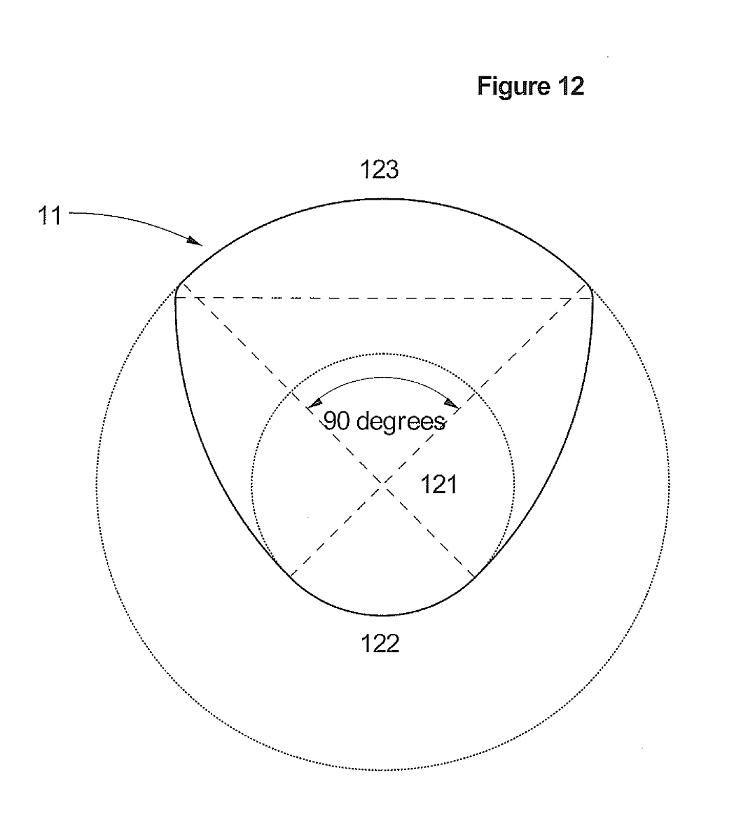

FIG. 12 illustrates a diagram of an embodiment of the 90°-dwell positive return cam. By placing the cam's (11) point of rotation (121) off the geometric center of the cam but at a common center point of the small dwell (122) and larger dwell (123) arc making up the 90°-dwell positive return cam, this cam (11) will push and pull the cam yoke back and forth with no need for springs and more importantly, the yoke can push back on the cam itself and force it to turn during some portions of the rotation.

The distinct working fluid distribution function of the Stirling engine is due to the geometry of the 90°-dwell positive return cam (11) governing the movement of its displaces and piston.

Every arc has its center at one of the intersections of the dotted construction lines. The two construction lines that pass through the center of rotation form a 90° angle. As discussed, the dwell-period arcs: 90° arc measure, are concentric with the center of rotation (121) of the cam.

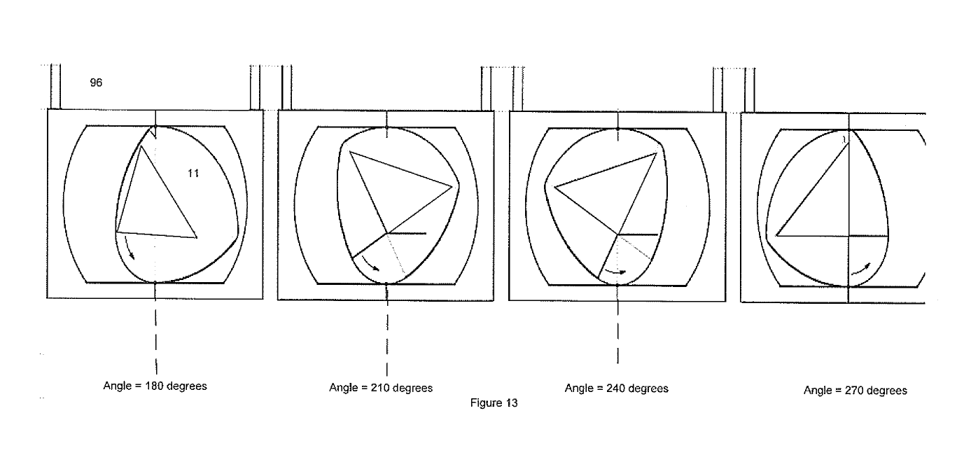

FIG. 13 illustrates a sequential diagram of an embodiment of the 90°-dwell positive return cam. The 90°-dwell positive return cam (11) has a shape of constant breadth constructed using circular arcs whose measurements add up to 360°, where each arc contacts a bearing surface of the yoke for a certain number of degrees of the rotation of the cam. For example, the first arc touches from 180 degrees to 210 degrees. The second arc touches from 210 degrees to 240 degrees, etc. The 90°-dwell positive return cam (11) has a cam profile that is a shape of constant breadth, which has, as part of its motion, two periods, where the yoke remains stationary for 90° of the cam's turn and a shape of constant breadth is the same breadth across, no matter what orientation it is measured from, and can therefore turn freely inside a fixed width snug-fitting yoke (96) with parallel bearing surfaces.

The 90°-dwell positive return cam (11) is one of the factors that enables the Liu-Stirling engine's PV cycle to match the Stirling cycle. The positive return cams (11) have a profile that is a shape of constant breadth; this permits the cam (11) to rotate freely within a fixed width yoke (96), pushing and pulling the yoke, whereas conventional cams require a spring to provide the return stroke of the cam follower. Positive return cams can enforce movement according to a desired function determined by the cam profile while extracting work during the phase where the yoke pushed by the piston rotates the cam. Observe from the illustration in this figure that the yoke (96) remains stationary for a full quarter of a turn of the cam (11); the cam (11) has two 90 degree periods per cycle where the yoke (96) remains stationary. The resulting motion is a series of four discrete phases, as required by the Stirling cycle.

The geometry of the 90°-dwell positive return cam (11) has a shape of constant breadth constructed using circular arcs where every component curve in the cam profile is a circular arc and every arc is tangent to the arcs in contact with it.

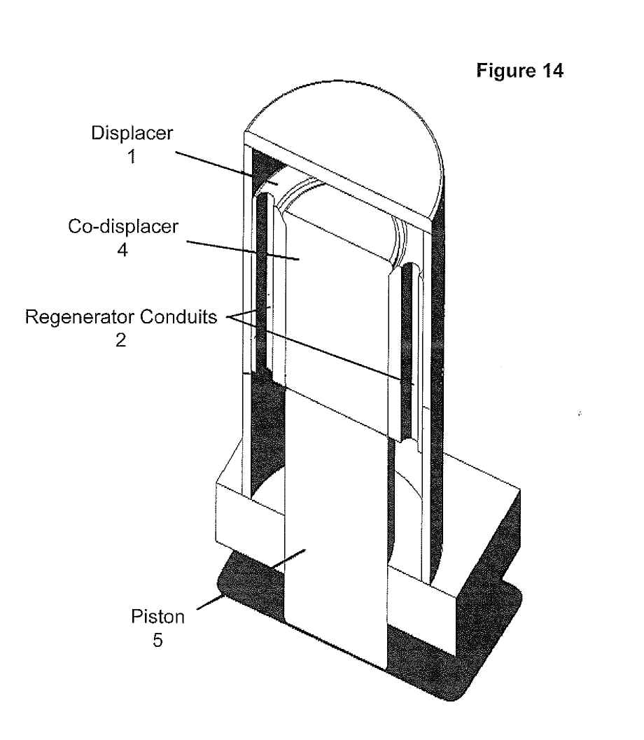

FIG. 14 illustrates a cross-section of an embodiment of the power piston, the main displacer and the co-displacer cooperating together.

The power piston (5) is aligned concentrically, or non-concentrically, to the main displacer (1) which forms a cylinder in which the power piston (5) can move. Whereas, the co-displacer (4) caps the main displacer (4) and the power piston (5) to separate the volume inside the shared cylinder into two areas, one heated, and one chilled. The co-displacer caps the main displacer by covering the area in the main displacer such that any working fluid above the displacer must go through the regenerator. In this embodiment, the power piston (5) is aligned on the same axis as the main displacer.

The main displacer (1) is annular and sits around the piston (5), and contains passages through it that house the regenerator (2). A co-displacer sits above the piston (5), and alternates between being locked with the piston (5) and with the displacer (1). The co-displacer fits inside the main displacer, and seals the chamber above the main displacer from the chamber below during high-volume displacement, forcing any working fluid pushed by the two to flow through the regenerators (2). During low-volume displacement, the co-displacer is locked to the piston and not to the displacer.

The power piston (5) slides back and forth through the main displacer (1). A regenerator conduit (2) through the Stirling engine's can sit outside of the engine cylinder and offers a passageway between the volume above the main displacer (1) and the volume below the main displacer (1). The regenerator conduit (2) could be packed with copper or steel wool making up the regenerator. The cam working in concert with the concentric piston (5), displacer (1), and co-displacer (4) solves the problem of expansion of the working fluid through the heat sink and results in the engine having a higher compression ratio.

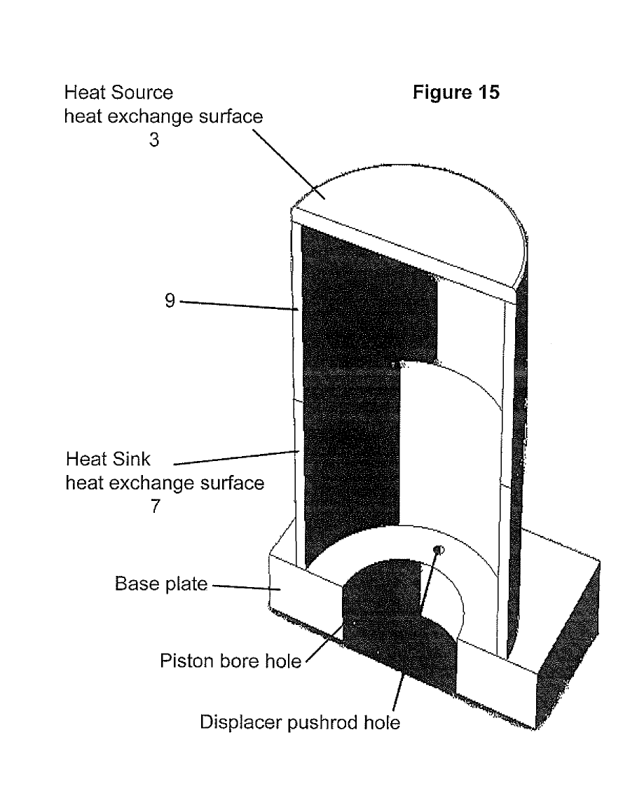

FIG. 15 illustrates a cross-section of an embodiment of the engine cylinder walls for the power piston, the main displacer and the co-displacer cooperating together. The engine cylinder (9) may have heat source surfaces (3) and heat sink surfaces (7).

The Stirling engine can be compared to the beta configuration of the Stirling engine. Like the beta-Stirling engine, in an embodiment this Stirling engine's piston can be coaxial with the displacer, but it differs from the standard beta-Stirling engine by having the power piston concentric to the displacer (which forms a cylinder in which the piston can move), while a co-displacer caps the displacer and piston to separate the volume inside the shared cylinder into two areas, one heated, and one chilled. No other Stirling engine uses a co-displacer, nor has the piston slide back and forth through the displacer.

The Stirling engine also differs from conventional Stirling engines in that its piston necessarily interfaces the drive shaft via positive return cams, whereas most Stirling engines use a crank system or scotch yokes.

Shapes of constant breadth are constructed using circular arcs whose measurements add up to 360°. Each arc contacts the bearing surfaces of the yoke for a certain number of degrees of the rotation of the cam.

The four sequential of FIGS. 3-6 show the engine states at the corners of the diagram of FIG. 16. States last for only a moment, and are the result of processes that correspond to the sides connecting the corners of the PV diagram. Phases are the periods during the cycle that carry out processes.

The Stirling engine can be applied to power the following example products: Hybrid cars and trucks, locomotives, ships, recreational sports craft, propeller-driven aircraft, concentrated solar power generators, self-powered harvesters, tractors, forklifts, back-up power generators, portable power generators, home and commercial combined heat and power furnaces, heat driven heat pumps, geothermal power plants, waste heat recovery generators, and possibly nuclear power plants and vessels.

The Stirling engine may not modulate its power output very easily or as responsively as an internal combustion engine. The solution to modulating power output is usually to use the engine in a hybrid system where the electrical motor and batteries or capacitors handle power output modulation while the engine generates electricity for the motor.

More aspects of the Stirling engine that provide additional benefits are high efficiency, fuel flexibility, clean emissions compared to internal combustion engines, and high power density compared to other Stirling engines. In particular, given the growing public concern over greenhouse gas emissions, global warming, and peak oil, we believe the Stirling engine's advantage of being able to utilize a variety of bio-fuels at a high efficiency give it an advantage over biodiesel-burning Diesel engines. The remaining aspects of this Stirling engine are quiet operation and simplicity of the engine.

The Stirling engine may cooperate with an Anisotropic Counter-flow Heat Exchanger such as a Gradient Maintaining Counter-flow Heat Exchanger. The Stirling Engine burns fuel and produces exhaust when it is used in its capacity as an engine.

In order to minimize the amount of fuel consumed to maintain the operating temperature of the heat source of a fuel burning Stirling engine, the air feeding the burners should be pre-heated as much as possible using heat reclaimed from the burners' own exhaust. Heat exchangers can be use for this purpose, but to optimize the efficiency of reclaiming heat from one gaseous medium to another (in this case, from exhaust to fresh air), the Anisotropic Counter-flow Heat Exchanger is offered. The Anisotropic Counter-flow Heat Exchanger is a device separate from the Stirling Engine that may be used with the engine.

The Anisotropic Counter-flow Heat Exchanger demonstrates higher exchange efficiency compared to other types of heat exchangers because throughout their entire length they minimize the temperature difference between the fluids flowing through them. Minimizing the temperature difference throughout the length of conduction minimizes the heat left unexchanged by the time the fluids exit the exchanger. This quality can be further enhanced by making the heat conducting body of the heat exchanger anisotropic—that is, by making the heat exchanger body conduct heat well in one direction while conducting heat poorly in another direction. In order to make the body of the heat exchanger anisotropic, the body of the heat exchanger is to be constructed of alternating laminates of conductive and insulating materials. This results in heat conducting well between the fluid channels within the body of the exchanger while conducting poorly along the length of the exchanger.

The reason this helps minimize the temperature difference is that the insulating laminates interferes with the tendency of heat to preferentially conduct along a conductive material rather than into a substance of lower conductivity. This tendency increases the temperature difference between the two fluids flowing throughout the exchanger, diminishing exchange efficiency. Since the application of this heat exchanger is for reclaiming heat out of one gaseous medium into another gaseous medium, and since gases have far lower conductivity than the materials used in heat exchangers, this efficiency robbing effect is especially pronounced and needs to be countered to maximize exchange efficiency. By interfering with the conduction of heat along the length of the exchanger by constructing the exchanger out of alternating laminates of conductive and insulating materials, the heat will preferentially conduct between the fluid channels within the exchanger, minimizing the temperature difference between the channels, thereby optimizing the exchange efficiency. Optimizing exchange efficiency will consequently optimize the efficiency of reclaiming heat from the exhaust of the Stirling engine, which will minimize the amount of fuel consumed by the Stirling engine's burners.

Stirling cycle devices behave as engines when they convert heat flow into work (such as turning a drive shaft), but they behave as heat pumps/refrigerators when they are forcibly worked (forcibly turning their drive shafts), which causes heat to flow. This heat flow will chill the place it is flowing from and heat the place it is flowing to. Unlike when used as an engine, when used as a heat pump, the heat source is cold (because it is having heat sucked out of it), and the heat sink is warm, because all of the heat taken from the heat source is being expelled through it. This same device is an incredibly efficient refrigeration device because the Stirling cycle is efficient both as a work cycle and as a heat pumping cycle.

The Stirling engine may be used as a heat pump in a method for refrigeration using the Stirling engine that implements the Stirling cycle in reverse.

A movement of a power piston and a main displacer coupled to a camshaft is governed by means of a 90°-dwell positive return cam and yoke system. The camshaft is the driveshaft for the engine.

The co-displacer is alternately locked between the main displacer and the power piston. The heat pump achieves gaseous working fluid displacement using the main displacer and the co-displacer, which enables the main displacer to displace a different volume of gaseous working fluid during a heat intake phase of the reversed Stirling cycle than during a heat expulsion phase of the Stirling cycle. The movement of the power piston and the main displacer are mutually exclusive. When one moves, the other must remain still, and vice versa, and thus the reciprocating movement of both the power piston and the main displacer is punctuated by pauses where each dwells at the end of its stroke as long as the other one is moving.

During a phase of the reversed Stirling cycle, the working fluid is compressed at a high temperature under high pressure with the piston to expel heat out of the heat sink. A significant portion of the hot working fluid is not exposed to the heat source which is being chilled.

During another phase of the reversed Stirling cycle, the volume is maintained nearly constant for isochoric cooling by the main displacer coupled to the co-displacer. The main displacer coupled to the co-displacer almost completely displaces the working fluid through the regenerator into the chamber in contact with the heat source so that the regenerator pre-chills almost all of the working fluid before it contacts the heat source, which is being chilled, so that any decompression of the working fluid causes it to absorb heat from the heat source.

During another phase of the reversed Stirling cycle, the gas working fluid is decompressed using the piston without exposing any of the working fluid to the heat sink surface when the gas working fluid is going through its heat intake phase by moving the co-displacer coupled to the piston, while the co-displacer and main displacer block the heat sink surface.

During another phase of the reversed Stirling cycle, the volume is maintained nearly constant for isochoric heating. The main displacer almost completely displaces the working fluid through the regenerator into the chamber in contact with the heat sink so that the regenerator pre-heats almost all of the working fluid before it contacts the heat sink, which is hot from heat being expelled through it, so that any compression of the working fluid causes it to expel heat through the heat source.

While some specific embodiments of the invention have been shown, the invention is not to be limited to these embodiments. The invention is to be understood as not limited by the specific embodiments described herein, but only by scope of the appended claims.

1. A Stirling engine that implements a Stirling cycle that is a closed cycle engine that continuously reuses its gaseous working fluid from cycle to cycle, comprising;
a power piston and a main displacer coupled to a camshaft by means of a 90°-dwell positive return cam and yoke system,
a co-displacer, in which the Stirling engine achieves gaseous working fluid displacement using the main displacer and the co-displacer, where the co-displacer alternately locks between the main displacer and the power piston, which enables the main displacer to displace a different volume of gaseous working fluid during a cooling phase of the Stirling cycle than during a heating phase of the Stirling cycle.

2. The Stirling engine of claim 1, wherein the co-displacer also enables the power piston and the main displacer to operate in a same volume while the co-displacer exerts influence on the entire volume of gaseous working fluid.

3. The Stirling engine of claim 1, wherein the power piston is aligned concentrically to the main displacer, which forms an engine cylinder in which the power piston can move, while the co-displacer caps the main displacer and the power piston to separate the volume inside the shared cylinder into two areas, one heated, and one chilled.

4. The Stirling engine of claim 1, wherein the power piston is aligned concentrically to the co-displacer in a cylinder in which the power piston can move, while the co-displacer has two or more latches to including a first latch to the main displacer and a second latch to the power piston to separate the volume inside the shared cylinder into two areas, one heated, and one chilled.

5. The Stirling engine of claim 3, wherein a wherein a regenerator sits within a conduit, and the conduit is located either 1) within the displacer or 2) outside the cylinder and the conduit connects the volume on a heat sink side of the main displacer to the volume on a heat source side of the main displacer.

6. The Stirling engine of claim 4, wherein a regenerator conduit may be integrated into a body of the main displacer and offers a passageway between a volume above the main displacer and a volume below the main displacer, and the regenerator within the conduit is made of a porous material with a high heat transfer/absorption capacity.

7. The Stirling engine of claim 1, wherein the power piston, the main displacer and the co-displacer cooperate together to implement four distinct phases of the Stirling cycle in order to increase efficiency and power density, where the power piston governs the volume inside the Stirling engine and the main displacer pushes the gaseous working fluid between a heat source and a heat sink to change a temperature of the gaseous working fluid, and the gaseous working fluid distribution in the four distinct phases of the Stirling cycle is due to a geometry of the 90°-dwell positive return cam that governs a movement of the main displacer and the power piston.

8. The Stirling engine of claim 7, wherein the movement of the power piston and the main displacer are mutually exclusive; when one moves, the other must remain still, and vice versa, and thus the reciprocating movement of both the power piston and the main displacer is punctuated by pauses where each dwells at the end of its stroke as long as the other one is moving.

9. The Stirling engine of claim 1, wherein the 90°-dwell positive return cam has a cam profile that is a shape of constant breadth, which has, as part of its motion, two periods, where a yoke remains stationary for 90° of the cam's turn and a shape of constant breadth is the same breadth across, no matter what orientation it is measured from, and can therefore turn freely inside a fixed width snug-fitting yoke with parallel bearing surfaces.

10. The Stirling engine of claim 9, wherein the 90°-dwell positive return cam has a point of rotation off the geometric center of the cam and by placing the cam's point of rotation off the geometric center of the cam but at a common center point of the small and larger dwell arcs making up the 90°-dwell positive return cam, this cam will push and pull the cam-yoke back and forth with no need for springs and more importantly, the yoke can push back on the cam itself and force it to turn during some portions of the rotation.

11. The Stirling engine of claim 1, wherein the 90°-dwell positive return cam has a shape of constant breadth constructed using circular arcs whose measurements add up to 360% where each arc contacts a bearing surface of a yoke for a certain number of degrees of the rotation of the 90°-dwell positive return cam.

12. The Stirling engine of claim 1, wherein a geometry of the 90°-dwell positive return cam has a shape of constant breadth constructed using circular arcs where every component curve in the cam profile is a circular arc and every arc is tangent to the arcs in contact with it.

13. The Stirling engine of claim 1, wherein the 90°-dwell positive return cams pull on cam followers, where the positive return cams sits inside yokes with parallel, flat bearing surfaces, and as the cams turn, they push on the bearing surfaces on one side of the yokes, then push on the bearing surfaces on the other side of the yokes upon the return stroke, while in contact with both bearing surfaces throughout the cycle, which then causes the return of the yoke by the cam's push on the return side's bearing surface, and the cam follower for the positive return cam is a yoke.

14. The Stirling engine of claim 1, wherein at least a portion of the co-displacer and the main displacer abut to span across the width of an engine cylinder such that the gaseous working fluid cannot pass from a first area in contact with a heat source to a second area of the engine cylinder in connection with a heat sink without passing through a regenerator.

15. The Stirling engine of claim 1, wherein the co-displacer has a first latch plate for locking a motion of the co-displacer with the displacer, a second latch plate for locking a motion of the co-displacer with the power piston, and a body connected to the first and second latch plates.

16. The Stirling engine of claim 15, wherein the main displacer has a regenerator of highly porous material to permit passage of gases without much resistance and is integrated into a portion of the main displacer's body, a latch to mechanically lock with the co-displacer, a pushrod coupled to the body of the main displacer, a yoke coupled to the pushrod.

17. The Stirling engine of claim 1, wherein the co-displacer couples to the power piston and a narrow plenum exist between the top of the body of the co-displacer and the inside wall of the top of the engine cylinder wall so that the gas working fluid presses down on the power piston via the coupled co-displacer so that the gas working fluid does not have to be exposed to a heat sink exchanging surface of the engine cylinder during the expansion phase of the Stirling cycle.

18. A method for generating work from a Stirling engine that implements a Stirling cycle, comprising;
governing movement of a power piston and a main displacer coupled to a camshaft that is a driveshaft for the engine by means of a 90°-dwell positive return cam and yoke system,
alternately locking a co-displacer between the main displacer and the power piston a co-displacer to achieve gaseous working fluid displacement using the main displacer and the co-displacer, which enables the main displacer to displace a different volume of gaseous working fluid during a cooling phase of the Stirling cycle than during a heating phase of the Stirling cycle, wherein the movement of the power piston and the main displacer are mutually exclusive; when one moves, the other must remain still, and vice versa, and thus the reciprocating movement of both the power piston and the main displacer is punctuated by pauses where each dwells at the end of its stroke as long as the other one is moving.

19. The method of claim 18, further comprising:
during a phase of the Stirling cycle, compressing low-temperature, low-pressure, working fluid with the piston without a significant portion of the working fluid exposed to a heat source; and
during another phase of the Stirling cycle maintaining volume nearly constant for isochoric heating by the main displacer almost completely displacing the working fluid through the regenerator into a heating chamber and then the gaseous working fluid increases in pressure unmitigated by pre-mature expansion.

20. The method of claim 18, further comprising:
during a phase of the Stirling cycle, expanding the gas working fluid against the piston without touching the heat sink surface when the gas working fluid is going through its expansion phase by moving the co-displacer coupled to the piston, while the co-displacer and main displacer block the heat sink surface.
